(19) United States
(12) Patent Application Publication
(10) Pub. No.: US 2005/0126143 A1
(43) Pub. Date: Jun. 16, 2005

(54) Oscillating quick-fit coupling, in particular for gardening machinery, and machinery fitted with said coupling

(75) Inventor: Paolo Tironi, Castel D' Ario (IT)

Correspondence Address: YOUNG & THOMPSON, 745 SOUTH 23RD STREET, 2ND FLOOR, ARLINGTON, VA, 22202, US

(73) Assignee: ROTOMEC S. P. A., NOGARA (VR) (IT)

(21) Appl. No.: 10/986,834

(22) Filed: Nov. 15, 2004

(30) Foreign Application Priority Data
Nov. 14, 2003 (IT) PC 2003 A 000050

(51) Int. Cl. A01D 75/30

(52) U.S. Cl. 56/6

(57) ABSTRACT

An oscillating quick-fit coupling for gardening machinery, includes a supporting structure designed to be fitted to a tractor, and a three-point linkage, connected to the machine, which is designed to be hooked onto the supporting structure, wherein the three-point linkage is connected to the machine via an articulated structure which allows the machine to perform limited oscillations in relation to the coupling. A series of hooks designed to engage corresponding elements integral with the coupling connected to the machine are fitted to the supporting structure connected to the tractor, which the hooks are equipped with devices designed to prevent the elements from becoming detached from the hooks, the devices being constituted by teeth which move between a position in which they interfere with the hooks and a retracted position, elastic structure designed to push the teeth into the interfering position being fitted.

This invention relates to an oscillating quick-fit coupling for gardening machinery, of the type comprising a supporting structure designed to be fitted to a tractor, and a three-point linkage, connected to the machine, which is designed to be hooked onto said supporting structure, wherein said three-point linkage is connected to the machine via an articulated structure which allows the machine to perform limited oscillations in relation to the coupling.

In this way, as the machine can perform limited vertical movements in relation to the coupling, and consequently the tractor, it follows the undulations of the terrain and cuts the grass at a constant, uniform height. According to an advantageous aspect of the invention, said support is fitted with quick-fit means which enable the coupling to be hooked onto the machine with no need for the operator to dismount from the tractor.

In particular, the supporting structure fixed to the tractor has a series of hooks with snap-on locking devices that engage corresponding parts of the coupling connected to the machine, which said coupling thus remains firmly secured to the supporting structure.

The three-point linkage is connected to the machine via a pair of lower arms, hinged on one side to the machine and on the other to the linkage and, at the top, via a pair of rods hinged to the support and the machine respectively on one side and to one another on the other side.

This configuration produces an articulated supporting structure which allows the machine to perform limited movements in height; the machine thus always remains in contact with the ground, with the blades at a constant height, even in the case of undulating terrain and a tractor which follows the undulations of the terrain.

The remainder of this description refers specifically to a mowing machine fitted with a coupling according to the invention, but the same solution idea could obviously also be applied to different types of gardening machinery. Currently known mowing machines are fitted, for the purpose of connection to a tractor, with a fixed coupling comprising a pair of pins connected to supports welded to the structure of the machine and, at the top, a third pin integral with a rigid framework, which is also connected to the structure of the mowing machine.

Said three pins are hooked to a coupling on the tractor, but as the resulting connection is rigid, the mowing machine is obliged to follow the oscillations of the tractor, and consequently cannot guarantee a uniform, constant cutting height.

Italian patent application no. PC 2000 U 020, filed by the same applicant, describes a mowing machine with an improved plate fitting system, which said machine comprises a main chassis designed to be connected to a tractor and a plurality of mowing pates mounted in such a way that they can oscillate on said chassis. For each group of cutting plates there is a support beam fitted between a pair of plates fixed to the chassis, and a pin, integral with said beam, that slides between two slots in said plates to allow the above-mentioned movements of the cutting plate.

This system allows the tools to follow small undulations in the ground, but is not enough to compensate for greater unevenness or to adjust the position of the machine when the tractor wheels encounter a dip, for example.

Consequently, known mowing machines still present some limitations in the case of land which is not perfectly prepared.

These drawbacks are now remedied by the present invention, which relates to an oscillating quick-fit coupling for gardening machinery, in particular for mowing machines, which comprises a supporting structure designed to be attached to the tractor and a three-point linkage connected to the machine and designed to be hooked onto said supporting structure, which said three-point linkage is connected to the machine via an articulated structure that allows the machine to oscillate and performed limited movements in height in relation to the coupling.

This invention will now be described in detail, by way of example but not of limitation, by reference to the annexed figures wherein:

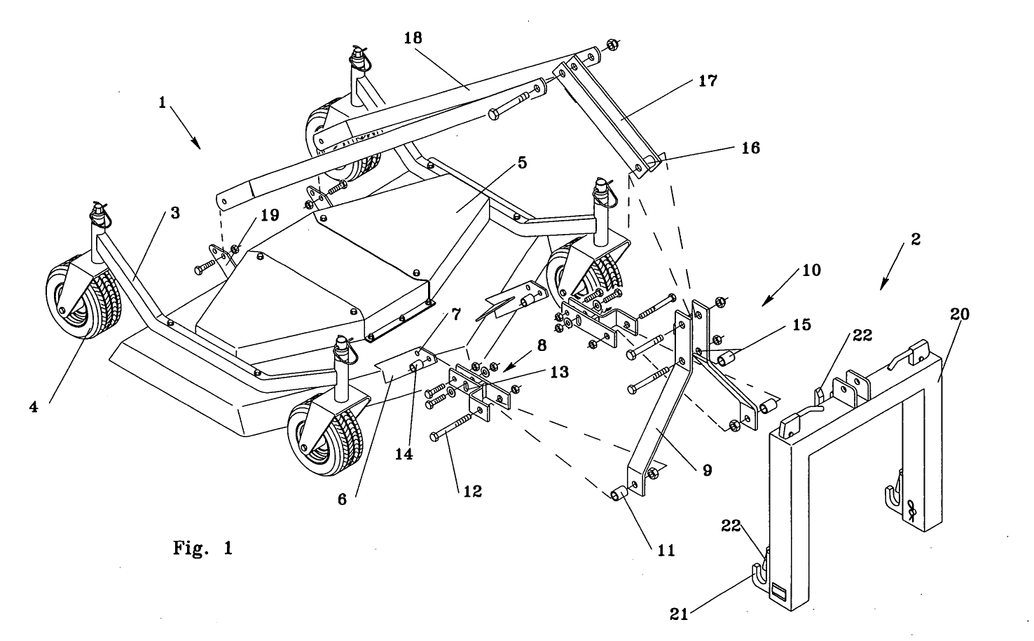

FIG. 1 shows an exploded perspective view of a mowing machine fitted with a coupling according to the invention;

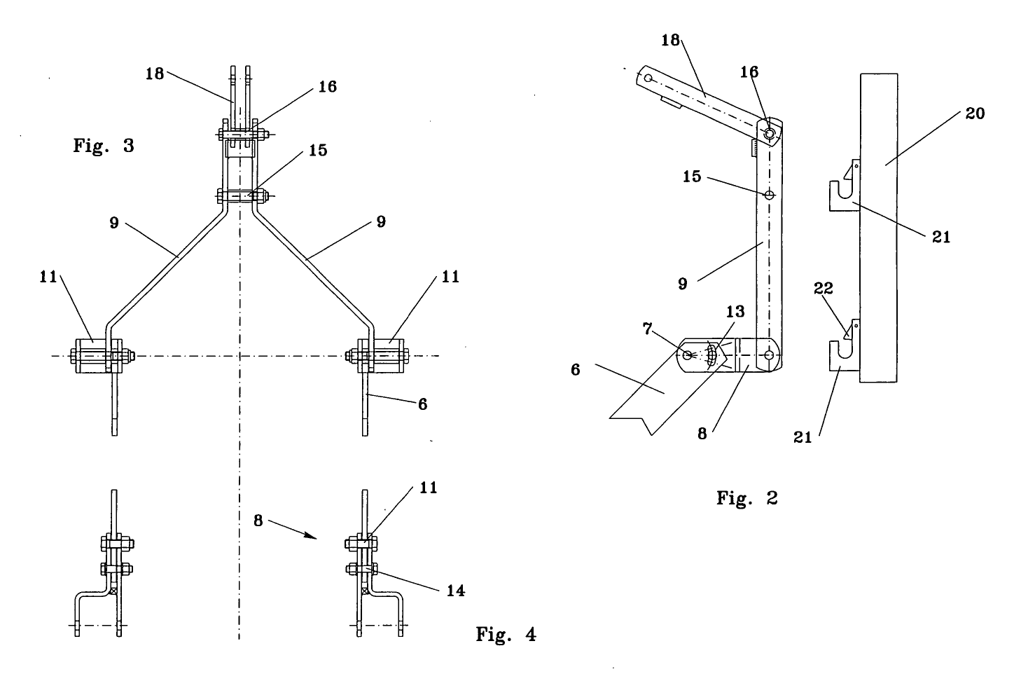

FIG. 2 shows the side view of the coupling according to the invention;

FIG. 3 shows the front view of the three-point linkage;

FIG. 4 shows a plan view of the lower part of the coupling.

In the annexed figures, no. 1 indicates a mowing machine assembly, fitted with an oscillating coupling shown as 2.

The mowing machine comprises a chassis 3 mounted on adjustable-height wheels 4, to which a structure 5 that supports one or more cutting blades, not shown in the figure, is fitted.

A pair of corner plates 6 are welded to the front of the structure of the machine, and each of said corner plates is hinged to a pair of arms 8 via bolts inserted into a first hole 7. Uprights 9 of a three-point linkage indicated as 10 and a pair of rollers 11 are connected to arms 8, close to the front end thereof.

Arms 8 are constituted by two metal plates or brackets, which are spaced sufficiently far apart at the front to allow roller 11 to be inserted between them.

A pin 14, bolted to the structure. is inserted into oblong slot 13 located in an intermediate position on arms 8. Arm 8 can then rotate around the axis of hole 7, and its oscillations are limited by the engagement between pin 14 and slot 13.

Uprights 9, which form linkage 10, are close together at the top, and a pair of rollers 15 and 16 are inserted between them. A pair of arms 17 are hinged to roller 16; arms 17 are hinged in turn to a pair of arms 18, which are hinged at the other end to a pair of sheet metal corner plates 19 welded to the back of the machine.

Arms 17 and 18 thus form an articulated structure which allows linkage 10 to perform limited vertical movements following the rotation of arms 8, always remaining vertical.

The coupling is completed by a supporting structure 20 constituted, for example, by a structural or tubular steel inverted U-section which is connected to the tractor and presents three hooks 21 in positions corresponding to those of rollers 11 and 15, which said hooks are designed to receive said rollers in order to hook linkage 10 to supporting structure 20.

Hooks 21 will preferably be associated with the same number of locking teeth 22, subject to the action of a spring which, when the rollers are inserted into the hooks, prevents them from exiting.

The coupling is used as follows.

When supporting structure 20 has been connected to the linkage present on the tractor, the mowing machine can be hooked up simply by matching hooks 21, integral with structure 20, with pins 11 and 15, and then raising structure 20 so that said pins are inserted into said hooks, causing the retraction of teeth 22, which exit when the pins are positioned due to the effect of the spring that locks the pins into position.

The mowing machine is now ready for use.

During its advance on the ground, when the machine encounters undulations it can oscillate freely in relation to the tractor; arms 8 rotating around the axis of hinge 7, and the articulated structure constituted by arms 17 and 18 allows linkage 10, hinged to arms 8, to move upwards and downwards, while remaining vertical, or in any event maintaining its original inclination.

This configuration allows the machine to be coupled to the tractor rapidly, with no need for the operator to dismount.

The width of the allowed oscillations will depend on the length of arms 8 and the dimensions of slot 13; the machine can consequently follow the contours of the terrain, always maintaining the blades at the same distance from the ground, even when the tractor encounters hills or valleys, so that the grass is cut at an even height.

An expert in the field could devise various modifications and variations, all of which should be deemed to fall within the ambit of this invention.

1) Oscillating quick-fit coupling for gardening machinery, of the type comprising a supporting structure designed to be connected to a tractor, and a three-point linkage connected to the machine, which said linkage is designed to be hooked onto said supporting structure, characterised in that said coupling is connected to the structure of the machine via an articulated structure which allows the machine to oscillate in relation to said support.

2) Oscillating quick-fit coupling for gardening machinery as claimed in claim 1, characterised in that said articulated structure comprises one or more arms hinged on one side to the front of the machine and on the other to the base of said coupling, and means designed to connect the third point of said linkage to the back of the machine.

3) Oscillating quick-fit coupling for gardening machinery as claimed in claim 2, characterised in that said means designed to connect the third point of said linkage to the back of the machine are constituted by at least a first arm hinged to the top of said coupling, and at least a second arm hinged to the back of the machine, said first and second arm being hinged to one another.

4) Oscillating quick-fit coupling for gardening machinery as claimed in claim 3, characterised in that a series of hooks designed to engage corresponding elements integral with said coupling connected to the machine are fitted to said supporting structure connected to the tractor, which said hooks are equipped with devices designed to prevent said elements from becoming detached from said hooks, said devices being constituted by teeth which move between a position in which they interfere with said hooks and a retracted position, elastic means designed to push said teeth into said interfering position being fitted.

5) Gardening machine characterised in that it includes a coupling as claimed in claim 4.
